(19) United States
(12) Patent Application Publication
(10) Pub. No.: US 2026/0031603 A1
(43) Pub. Date: Jan. 29, 2026

(54) ASSEMBLY

(71) Applicant: Yazaki Corporation, Tokyo (JP)

(72) Inventors: Kazuki KOBAYASHI, Kakegawa-shi (JP); Naoki SAKAGUCHI, Kakegawa-shi (JP); Shinya OISHI, Kakegawa-shi (JP)

(73) Assignee: Yazaki Corporation, Tokyo (JP)

(21) Appl. No.: 19/266,489

(22) Filed: Jul. 11, 2025

(30) Foreign Application Priority Data
Jul. 29, 2024 (JP) 2024-122159

(51) Int. Cl. H02G 3/14

(52) U.S. Cl. CPC H02G 3/14

(57) ABSTRACT

An assembly includes a cover body that has a guide surface and an opening; and a slide cover that is slid along the guide surface to close the opening, in which the slide cover has a slide surface facing the guide surface, the slide cover includes a first locking portion that protrudes from the slide surface, the first locking portion has a first locking surface, and a first continuous surface that is continuously arranged to the first locking surface and includes a first inclined surface, the cover body includes a second locking portion that protrudes from the guide surface, the second locking portion has a second continuous surface including a second inclined surface, and a second locking surface that is continuously arranged to the second continuous surface.

### BACKGROUND OF THE INVENTION

### Field of the Invention

The present disclosure relates to an assembly.

The present application claims priority to Japanese Patent Application No. 2024-122159 filed in Japan on Jul. 29, 2024, the contents of which are incorporated herein by reference.

### Description of Related Art

An assembly in which a cover material is slid is known.

For example, Patent Document 1 discloses “an in-vehicle electrical connection box comprising: a cover member configured to be slid from one end on a rear end side in a length direction toward a front, to cover a terminal and/or connector connected to a wire end after the terminal and/or connector is mounted in a terminal insertion cavity and/or connector accommodation portion provided on either a top or bottom surface of a rectangular parallelepiped-shaped case body. The cover member does not close a front portion side in the length direction of the case body, and has an opening for drawing out wires. Rail portions are projected from outer surfaces of both side walls of the case body in the length direction, locking pins are projected at front end positions of the rail portions, and guide portions are projected from inner surfaces of both side walls of the cover member so as to slide along upper and lower surfaces of the rail portions. The cover member is provided with locking grooves into which the locking pins are inserted and engaged. The cover member includes a rear end wall formed as an inclined wall, an outer fitting wall that is continuous with a distal end of the inclined wall and is externally fitted to a rear side wall of the case body, and a rib protruding from an inner surface of the inclined wall. The rib passes over the rear side wall of the case body and presses against an inner surface of the rear side wall so that the rear side wall of the case body is sandwiched between the rib and the outer fitting wall to suppress play between the case body and the cover member”.

### PRIOR ART DOCUMENT

### Patent Document

Patent Document 1: Japanese Unexamined Patent Application, First Publication No. 2009-95190

### SUMMARY OF THE INVENTION

In the electrical connection box disclosed in Patent Document 1, the rib passes over the rear side wall of the case body, and the rib abuts on the inner surface of the rear side wall, so that the rear side wall of the case body is sandwiched between the rib and the outer fitting wall, thereby restricting the movement of the case body in the length direction.

However, in the cover material disclosed in Patent Document 1, the cover material may come off depending on the holding force applied to the case body by the rib and the outer fitting wall.

An object of an embodiment is to provide an assembly in which a cover material is less likely to come off.

An assembly according to an embodiment includes a cover body that has a guide surface facing in a first direction and an opening through which a live part is exposed; and a slide cover that is slid in a second direction along the guide surface while facing the guide surface, to close the opening, in which the slide cover has a slide surface facing the guide surface when the slide cover is slid, the slide cover includes a first locking portion that protrudes from the slide surface in a third direction opposite to the first direction, the first locking portion has a first locking surface facing in a fourth direction opposite to the second direction, and has a first continuous surface continuously arranged in the second direction with respect to the first locking surface, the first continuous surface includes a first inclined surface that faces in a direction inclined in the second direction with respect to the third direction, the cover body includes a second locking portion that protrudes from the guide surface in the first direction, the second locking portion has a second continuous surface, and a second locking surface that is continuously arranged in the second direction with respect to the second continuous surface and faces in the second direction, and the second continuous surface includes a second inclined surface that faces in a direction inclined in the fourth direction with respect to the first direction.

According to one embodiment, a cover material of an assembly is less likely to come off.

### BRIEF DESCRIPTION OF THE DRAWINGS

FIG. 1 is a perspective view illustrating an assembly of an embodiment.

FIG. 2 is a side view illustrating the assembly of the embodiment.

FIG. 3 is a plan view illustrating the assembly of the embodiment.

FIG. 4 is a perspective view illustrating a case body of the embodiment.

FIG. 5 is a plan view illustrating the case body of the embodiment.

FIG. 6 is a rear view illustrating the case body of the embodiment.

FIG. 7 is a cross-sectional view taken along line F7-F7 of a structure illustrated in FIG. 5.

FIG. 8 is a perspective view illustrating a slide cover of the embodiment.

FIG. 9 is a plan view illustrating the slide cover of the embodiment.

FIG. 10 is a rear view illustrating the slide cover of the embodiment.

FIG. 11 is a cross-sectional view taken along line F11-F11 of a structure illustrated in FIG. 9.

FIG. 12 is a cross-sectional view taken along line F12-F12 of a structure illustrated in FIG. 3.

FIG. 13 is a cross-sectional view I showing an insertion procedure of the slide cover in the assembly of the embodiment.

FIG. 14 is a cross-sectional view II showing the insertion procedure of the slide cover in the assembly of the embodiment.

FIG. 15 is a cross-sectional view III showing the insertion procedure of the slide cover in the assembly of the embodiment.

FIG. 16 is a cross-sectional view IV showing the insertion procedure of the slide cover in the assembly of the embodiment.

FIG. 17 is a cross-sectional view V showing the insertion procedure of the slide cover in the assembly of the embodiment.

FIG. 18 is a cross-sectional view illustrating a modification example of an embodiment.

### DETAILED DESCRIPTION OF THE INVENTION

Hereinafter, each embodiment according to the present disclosure will be described with reference to the drawings. Note that the drawings and specific constitutions used in each embodiment should not be used to interpret the disclosure. In all the drawings, the same or corresponding constitutions are denoted by the same reference numbers, and the common description will be omitted.

In the present disclosure, the +X direction, the −X direction, the +Y direction, the −Y direction, the +Z direction, and the −Z direction are defined as follows. The +Z direction is a direction in which a guide surface faces. The −Z direction is a direction opposite to the +Z direction. Hereinafter, in a case where the +Z direction and the −Z direction are not distinguished, the directions are simply referred to as “Z direction”. The +X direction is a direction in which a slide cover 2 is slid. The −X direction is a direction opposite to the +X direction. Hereinafter, in a case where the +X direction and the −X direction are not distinguished, the directions are simply referred to as “X direction”. The +Y direction and the −Y direction are directions intersecting (for example, orthogonal to) the X direction and the Z direction. The +Y direction is a direction from a third wall portion toward a fourth wall portion. The −Y direction is a direction opposite to the +Y direction. Hereinafter, in a case where the +Y direction and the −Y direction are not distinguished, the directions are simply referred to as “Y direction”. The +Z direction is an example of a “first direction”. The +X direction is an example of a “second direction”. The −Z direction is an example of a “third direction”. The −X direction is an example of a “fourth direction”. The +Y direction is an example of a “fifth direction”. The −Y direction is an example of a “sixth direction”.

Note that the above expression is an expression for convenience of description, and does not limit the insertion direction of the slide cover 2 (an installation posture of an assembly 100).

### First Embodiment

Hereinafter, an assembly of an embodiment will be described with reference to the drawings.

The cover material in the present disclosure is the slide cover 2.

### (Constitution of Assembly)

The assembly 100 covers a live part housed inside with the slide cover 2. The assembly 100 is used to avoid unintentional exposure of the live part.

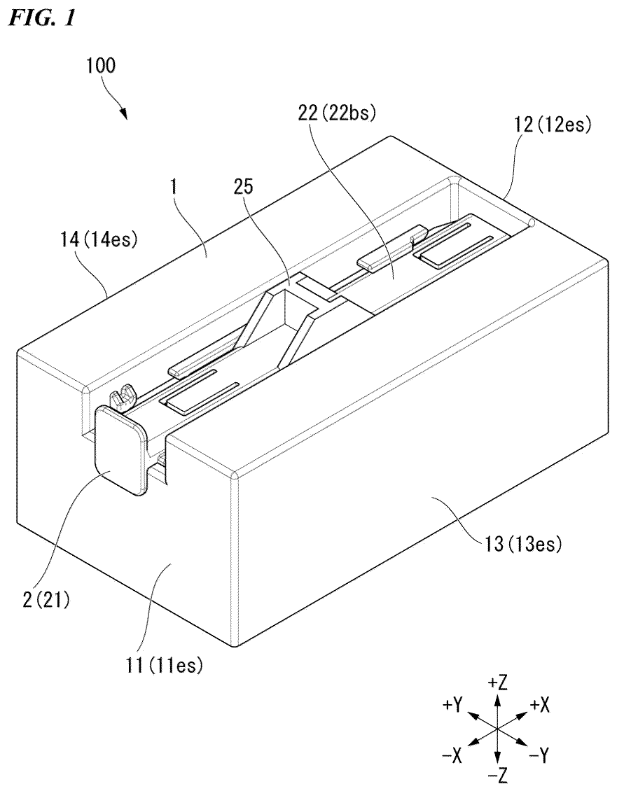

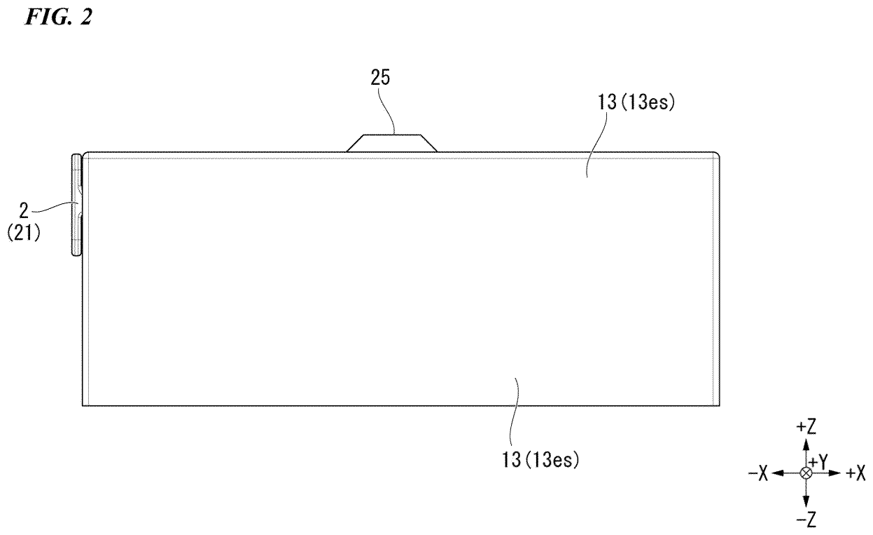

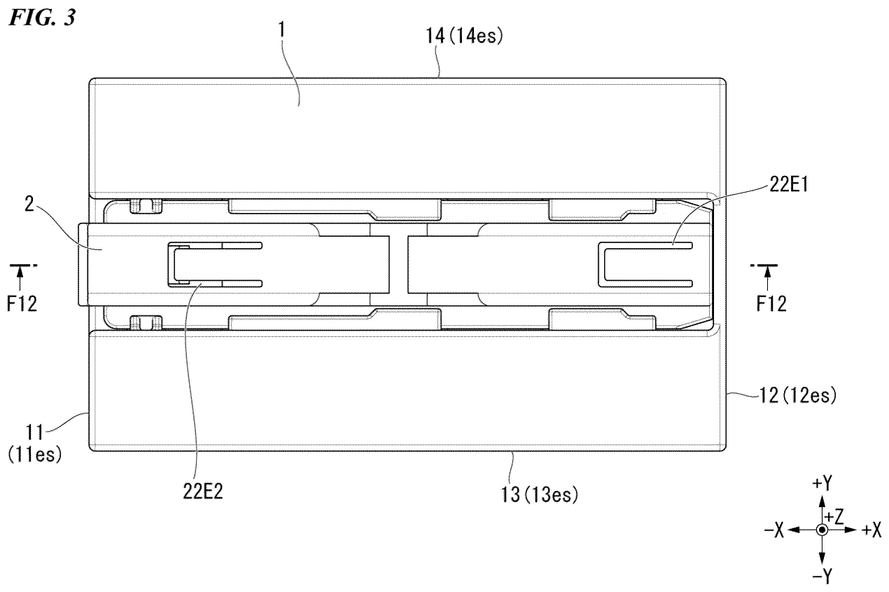

As illustrated in FIGS. 1 to 3, an assembly 100 of the present embodiment includes a cover body 1 and the slide cover 2. For example, the assembly 100 may be mounted on a mobility unit such as an electric vehicle.

### (Constitution of Cover Body)

The cover body 1 houses the live part.

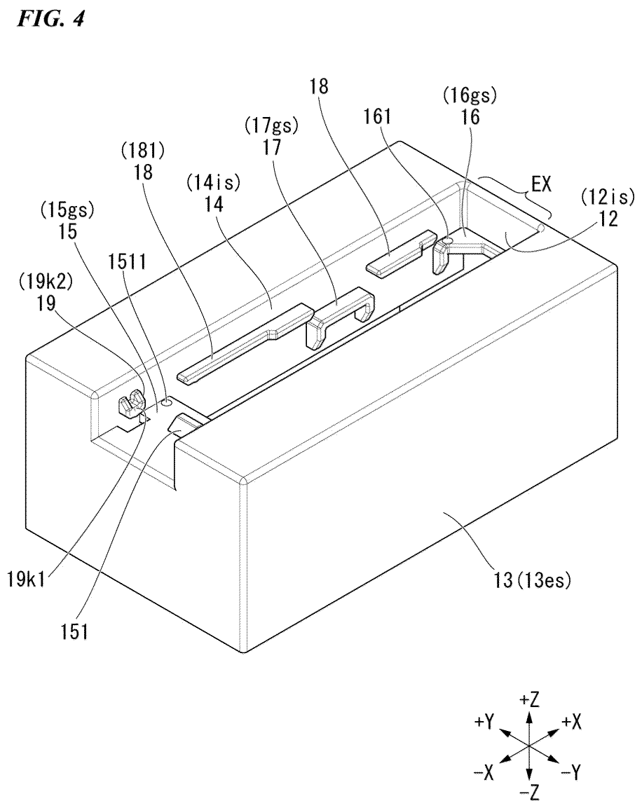

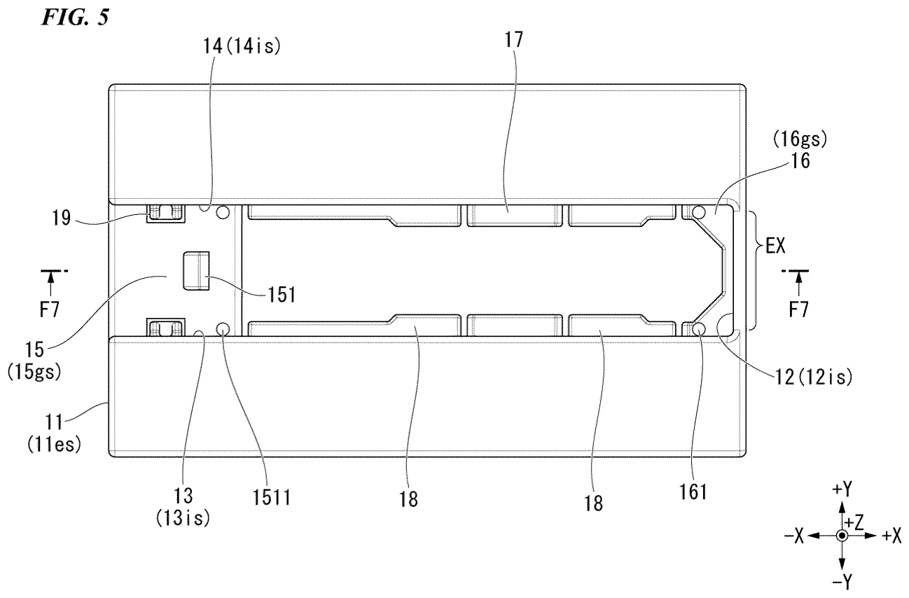

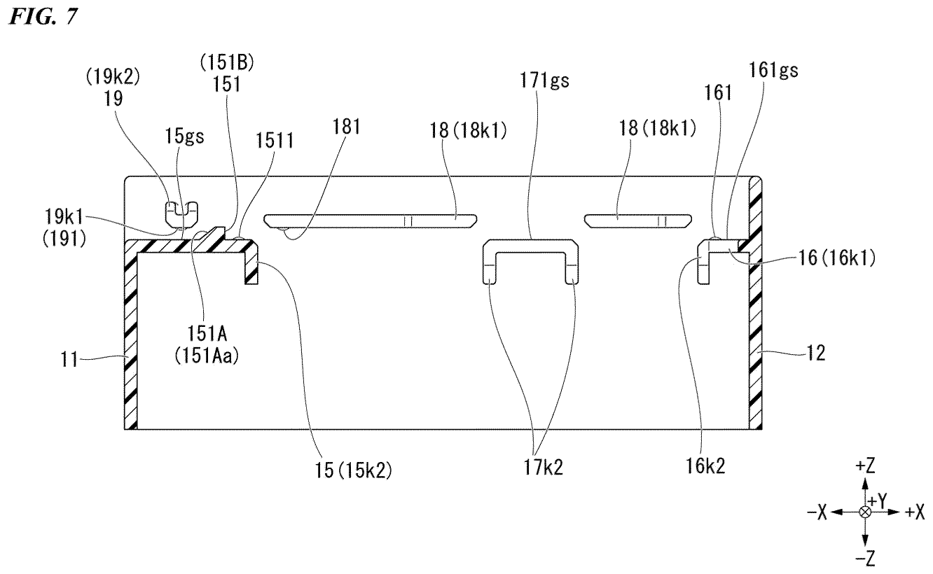

As illustrated in FIGS. 4 to 7, the cover body 1 includes a first wall portion 11, a second wall portion 12, a third wall portion 13, a fourth wall portion 14, a first rail portion 15, a second rail portion 16, at least one lower protrusion 17, at least one upper protrusion 18, and a restricting portion 19. For example, in the present embodiment, the cover body 1 includes one lower protrusion 17 and two upper protrusions 18. The numbers of the lower protrusions 17 and the upper protrusions 18 are not limited.

The cover body 1 has an opening EX. The live part is exposed through the opening EX. For example, in the present embodiment, the cover body 1 has the opening EX formed by the first wall portion 11, the second wall portion 12, the third wall portion 13, and the fourth wall portion 14.

The cover body 1 has a guide surface 15gs. The slide cover 2 is slidable along the guide surface 15gs while facing the guide surface 15gs.

### (Constitution of Each Wall Portion)

The first wall portion 11 has an outer wall surface 11es facing the −X direction and an inner wall surface 11is facing the +X direction. The second wall portion 12 has an outer wall surface 12es facing the +X direction and an inner wall surface 12is facing the −X direction. The third wall portion 13 has an outer wall surface 13es facing the −Y direction and an inner wall surface 13is facing the +Y direction. The fourth wall portion 14 has an outer wall surface 14es facing the +Y direction and an inner wall surface 14is facing the −Y direction.

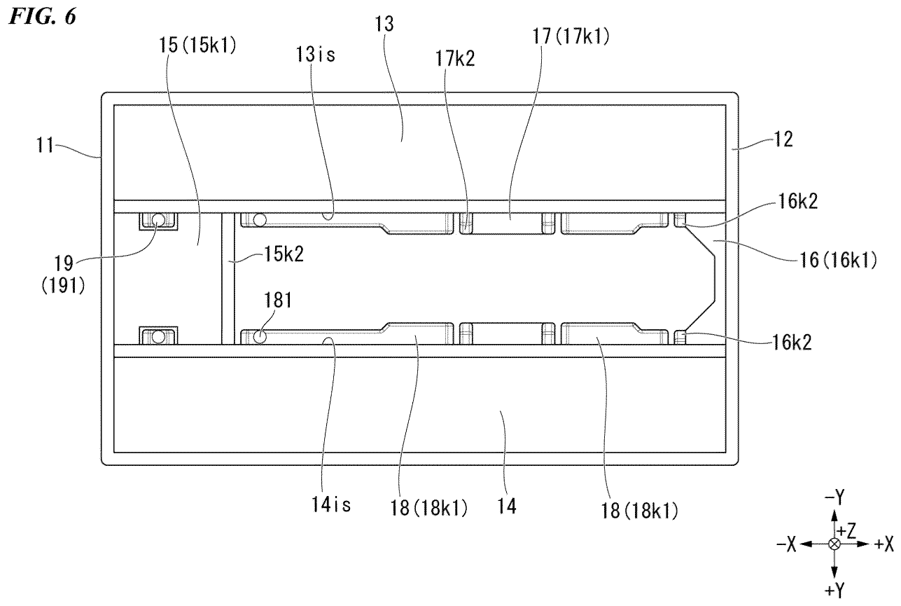

As illustrated in FIG. 6, the third wall portion 13 may have a hollow structure therein. The fourth wall portion 14 may have a hollow structure therein.

### (Constitution of First Rail Portion)

The first rail portion 15 bridges the inner surfaces of both side walls in the Y direction. That is, the first rail portion 15 bridges the inner wall surface 13is and the inner wall surface 14is. The first rail portion 15 includes a flat portion 15k1 extending in the X direction, and at least one or more upright portions 15k2 that are connected to the flat portion 15k1 and extend in the Z direction. When a load is applied in the −Z direction via the slide cover 2, deformation of the first rail portion 15 is suppressed by the upright portion 15k2.

The first rail portion 15 of the cover body 1 has the guide surface 15gs facing the first direction. In the present embodiment, a surface of the flat portion 15k1 facing the +Z direction is the guide surface 15gs. The first rail portion 15 allows the slide cover 2 to be slid along the guide surface 15gs.

In the present embodiment, for example, the first rail portion 15 and the first wall portion 11 are connected.

The first rail portion 15 may include a protrusion 1511 that protrudes in the +Z direction.

The protrusion 1511 is arranged in the +X direction with respect to a second locking portion 151.

The cover body 1 includes the second locking portion 151. The second locking portion 151 protrudes from the guide surface 15gs in the +Z direction.

### (Second Locking Portion)

The second locking portion 151 will be described in detail prior to a first locking portion 23, which will be described later.

The second locking portion 151 has a second continuous surface 151A and a second locking surface 151B. The second continuous surface 151A and the second locking surface 151B are connected by an end portion ED.

The second locking surface 151B is continuously arranged in the +X direction with respect to the second continuous surface 151A, and faces in the +X direction. The second locking surface 151B is a surface along the +Z direction.

The second continuous surface 151A includes a second inclined surface 151Aa facing in a direction inclined in the −X direction with respect to the +Z direction.

### (Constitution of Second Rail Portion)

The second rail portion 16 is arranged in the +X direction with respect to the first rail portion 15.

Similarly to the first rail portion 15, the second rail portion 16 bridges the inner surfaces of both side walls in the Y direction. The second rail portion 16 includes a flat portion 16kl extending in the X direction, and at least one or more upright portions 16k2 that are connected to the flat portion 16kl and extend in the Z direction. The upright portion 16k2 decreases in protrusion amount from a wall surface as the upright portion 16k2 extends in the −Z direction. When a load is applied in the −Z direction via the slide cover 2, deformation of the second rail portion 16 is suppressed by the upright portion 16k2.

The second rail portion 16 has a guide surface 16gs on the same plane as the guide surface 15gs. In the present embodiment, a surface of the flat portion 16kl facing the +Z direction is the guide surface 16gs.

In the present embodiment, for example, the second rail portion 16 and the second wall portion 12 are connected.

The second rail portion 16 may include a protrusion 161 that protrudes in the +Z direction.

The protrusion 161 is arranged in the +X direction with respect to the second locking portion 151.

For example, in the present embodiment, the first rail portion 15 includes one upright portion 15k2, and the second rail portion 16 includes two upright portions 16k2. The upright portion 16k2 has a shape that is partially extracted from one upright portion 15k2. In comparison of sectional areas in the Y direction, the sectional area of the upright portion 16k2 is smaller than the sectional area of the upright portion 15k2. The cover body 1 receives a force in the −Z direction via the second locking portion 151. This force acts more strongly on the first rail portion 15 than on the second rail portion 16. In a case where the sectional area in the X direction is the same between the upright portion 15k2 and the upright portion 16k2, the upright portion 15k2 is larger than the upright portion 16k2 in the sectional area in the Y direction.

### (Constitution of Lower Protrusion)

The lower protrusion 17 is a pair of protrusions protruding from the inner surfaces of both side walls in the Y direction. For example, in the present embodiment, the lower protrusion 17 has a protrusion protruding from the inner wall surface 13is and a protrusion protruding from the inner wall surface 14is. The lower protrusion 17 includes a flat portion 17k1 extending in the X direction, and at least one or more upright portions 17k2 that are connected to the flat portion 17k1 and extend in the Z direction. The upright portion 17k2 decreases in protrusion amount from a wall surface as the upright portion 17k2 extends in the −Z direction. When a load is applied in the −Z direction via the slide cover 2, deformation of the lower protrusion 17 is suppressed by the upright portion 17k2.

The lower protrusion 17 has a guide surface 17gs on the same plane as the guide surface 15gs. In the present embodiment, a surface of the flat portion 17k1 facing the +Z direction is the guide surface 17gs.

### (Constitution of Upper Protrusion)

The upper protrusion 18 is positioned in the +Z direction with respect to the lower protrusion 17.

The upper protrusion 18 is a pair of protrusions protruding from the inner surfaces of both side walls in the Y direction. That is, the upper protrusion 18 has a protrusion protruding from the inner wall surface 13is and a protrusion protruding from the inner wall surface 14is. The upper protrusion 18 includes a flat portion 18k1 extending in the X direction. The upper protrusion 18 restricts the movement of the slide cover 2 in the +Z direction. For example, the movement of the slide cover 2 in the +Z direction is restricted by inserting an ear portion 22k2 of the slide cover 2 between the upper protrusion 18 and the lower protrusion 17.

The upper protrusion 18 may include a protrusion 181 that protrudes in the −Z direction.

When viewed from the +Z direction, the first rail portion 15, the second rail portion 16, at least one lower protrusion 17, and at least one upper protrusion 18 are arranged alternately in the X direction. In other words, the first rail portion 15, the second rail portion 16, at least one lower protrusion 17, and at least one upper protrusion 18 do not overlap in the Z direction.

When viewed from the +Z direction, the first rail portion 15 and the restricting portion 19 overlap each other in the Z direction.

### (Constitution of Restricting Portion)

The restricting portion 19 is arranged in the +Z direction with respect to the first rail portion 15.

The restricting portion 19 is a pair of protrusions protruding from the inner surfaces of both side walls in the Y direction. The restricting portion 19 includes a flat portion 19k1 extending in the X direction, and at least one or more upright portions 19k2 that are connected to the flat portion 19k1 and extend in the Z direction. The upright portion 19k2 decreases in protrusion amount from a wall surface as the upright portion 19k2 extends in the +Z direction. When a load is applied in the Z direction via the slide cover 2, the movement of the slide cover 2 is restricted by the upright portion 19k2.

For example, in the present embodiment, the cover body 1 includes two upper protrusions 18, and the cover body 1 includes the restricting portion 19. In comparison of sectional areas in the X direction, the sectional area of the restricting portion 19 is smaller than the sectional area of the upper protrusion 18. The cover body 1 receives a force in the +Z direction via the second locking portion 151. This force acts more strongly on the restricting portion 19 than on the upper protrusion 18. Therefore, in order to suppress deformation of the restricting portion 19, the restricting portion 19 includes the upright portion 19k2 that serves a reinforcing function.

The restricting portion 19 may include a protrusion 191 that protrudes in the −Z direction.

The protrusion 191 is arranged in the −X direction with respect to the second locking portion 151.

### (Constitution of Slide Cover)

The slide cover 2 can be slid in the +X direction along the guide surface 15gs while facing the guide surface 15gs, to close the opening EX. At this time, the live part is covered by the slide cover 2.

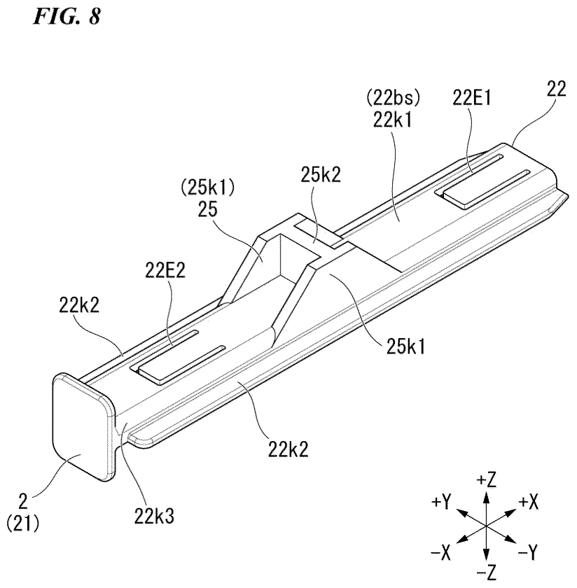

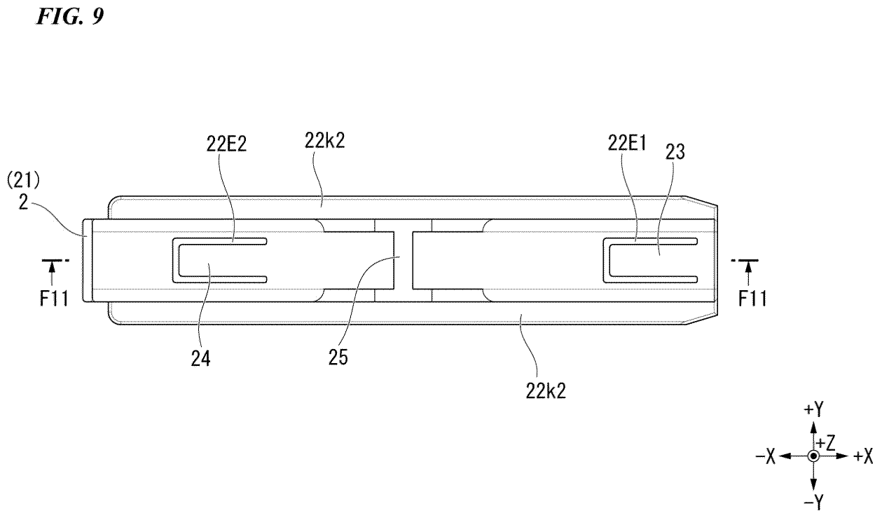

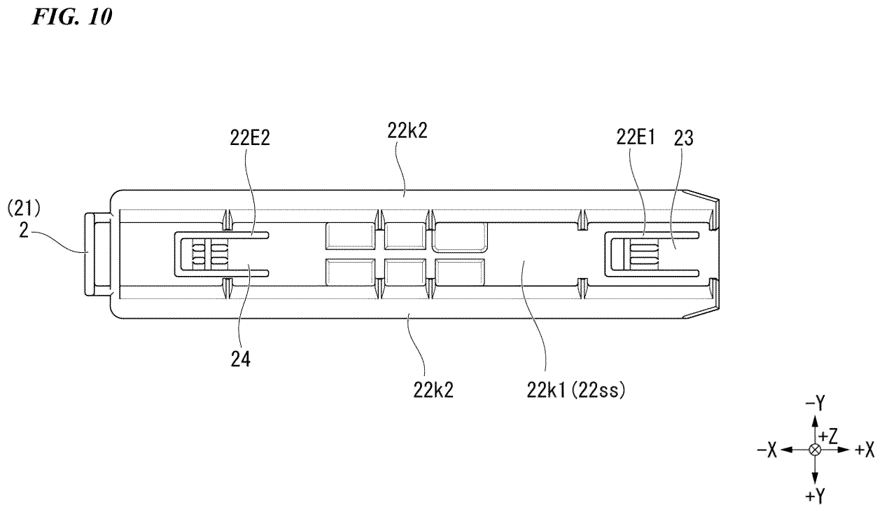

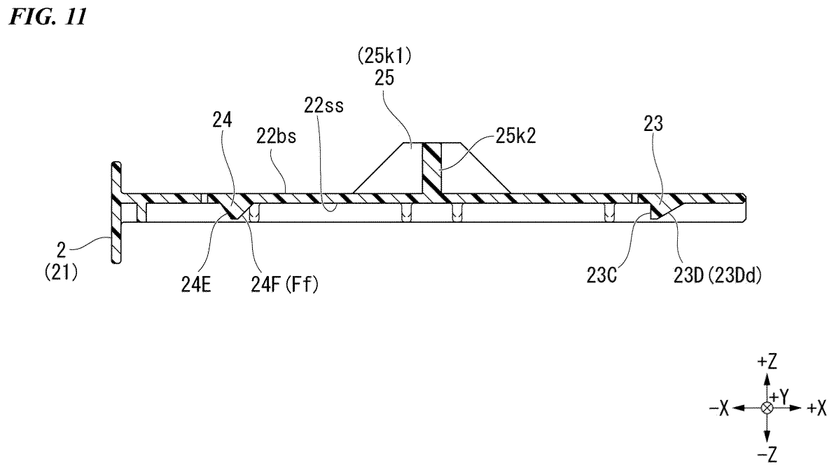

As illustrated in FIGS. 8 to 11, the slide cover 2 includes a grip portion 21, an extension portion 22, the first locking portion 23, a third locking portion 24, and a reinforcement portion 25.

### (Constitution of Grip Portion)

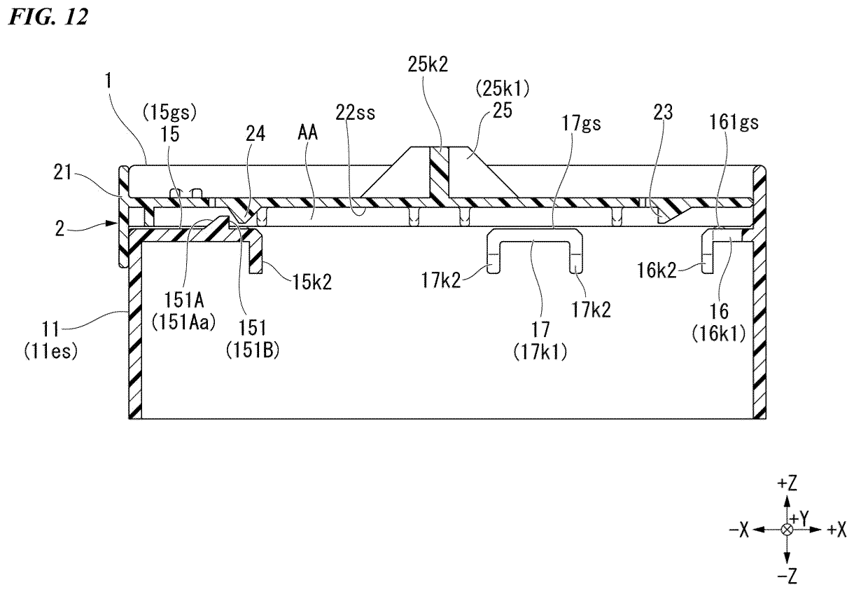

The grip portion 21 can come into contact with the outer wall surface 11es to allow the insertion position of the slide cover 2 to be visually confirmed. For example, in the present embodiment, a target insertion position (hereinafter also referred to as a “locking position”) is set at a position where the third locking portion 24 passes over the second locking portion 151 and becomes aligned with the second locking surface 151B in the X direction. FIG. 12 illustrates an example of the locking position. At this time, the grip portion 21 is in contact with the outer wall surface 11es.

### (Constitution of Extension Portion)

The length of the extension portion 22 with respect to the grip portion 21 is appropriately set such that the first locking portion 23 is aligned with the second locking surface 151B in the X direction. For example, in the present embodiment, the length of the extension portion 22 with respect to the grip portion 21 is set such that the first locking portion 23 and the third locking portion 24 are aligned with the second locking surface 151B in the X direction.

The extension portion 22 includes a flat portion 22k1 extending in the X direction, at least one or more ear portions 22k2 located in the −Z direction with respect to the flat portion 22k1, and at least one or more upright portions 22k3 that are connected to the flat portion 22k1 and the ear portion 22k2 and extend in the Z direction. The ear portion 22k2 is capable of coming into contact with the guide surface 15gs.

The slide cover 2 has a slide surface 22ss. The slide surface 22ss faces the guide surface 15gs when the slide cover 2 is slid. Since the slide cover 2 includes the ear portion 22k2 and the upright portion 22k3, a gap AA is provided between the guide surface 15gs and the slide surface 22ss. The first locking portion 23 and the third locking portion 24 are provided so as to partially fill the gap AA.

### (Constitution of First Locking Portion)

The first locking portion 23 protrudes from the slide surface 22ss in the −Z direction. The first locking portion 23 may have a slit.

The first locking portion 23 has a first locking surface 23C and a first continuous surface 23D.

The first locking surface 23C faces in the −X direction. The first locking surface 23C is a surface along the +Z direction.

The first continuous surface 23D is continuously arranged in the +X direction with respect to the first locking surface 23C. The first continuous surface 23D includes a first inclined surface 23Dd facing in a direction inclined in the +X direction with respect to the −Z direction.

### (Constitution of Third Locking Portion)

The third locking portion 24 is arranged in the −X direction with respect to the first locking portion 23 and protrudes from the slide surface 22ss in the −Z direction. The third locking portion 24 may have a slit.

The third locking portion 24 has a third inclined surface 24E and a third continuous surface 24F.

The third inclined surface 24E faces in a direction inclined in the −X direction with respect to the −Z direction.

The third continuous surface 24F is continuously arranged in the +X direction with respect to the third inclined surface 24E. The third continuous surface 24F includes a fourth inclined surface 24Ff facing in a direction inclined in the +X direction with respect to the −Z direction.

The first locking portion 23 is swingable from the slide surface 22ss toward a back surface 22bs of the slide surface. The third locking portion 24 is swingable from the slide surface 22ss toward the back surface 22bs of the slide surface. For example, the extension portion 22 has a first opening portion 22E1 and a second opening portion 22E2. The first opening portion 22E1 is open from the slide surface 22ss to the back surface 22bs. The second opening portion 22E2 is open alongside the first opening portion 22E1 in the −X direction, and is open from the slide surface 22ss to the back surface 22bs.

The first opening portion 22E1 is a U-shaped opening that sandwiches the first locking portion 23 in a direction along the +Y direction.

The second opening portion 22E2 is a U-shaped opening that sandwiches the third locking portion 24 in a direction along the +Y direction.

### (Constitution of Reinforcement Portion)

Mainly, the extension portion 22 of the slide cover 2 receives a force in the +Z direction by the second locking portion 151 via the first locking portion 23 and the third locking portion 24. Since the upper protrusion 18 restricts movement of the slide cover 2 in the +Z direction, bending may occur between the first locking portion 23 and the third locking portion 24. The reinforcement portion 25 serves to ensure the rigidity of the extension portion 22.

The reinforcement portion 25 includes two wall portions 25k1 and a bridge portion 25k2. The wall portion 25k1 is erected from the back surface 22bs in the +Z direction. The bridge portion 25k2 bridges one wall portion 25k1 and the other wall portion 25k1.

### (Operations of First Locking Portion and Third Locking Portion)

FIG. 12 illustrates the slide cover 2 at the locking position.

A procedure for causing the slide cover to reach the locking position will be described in detail below.

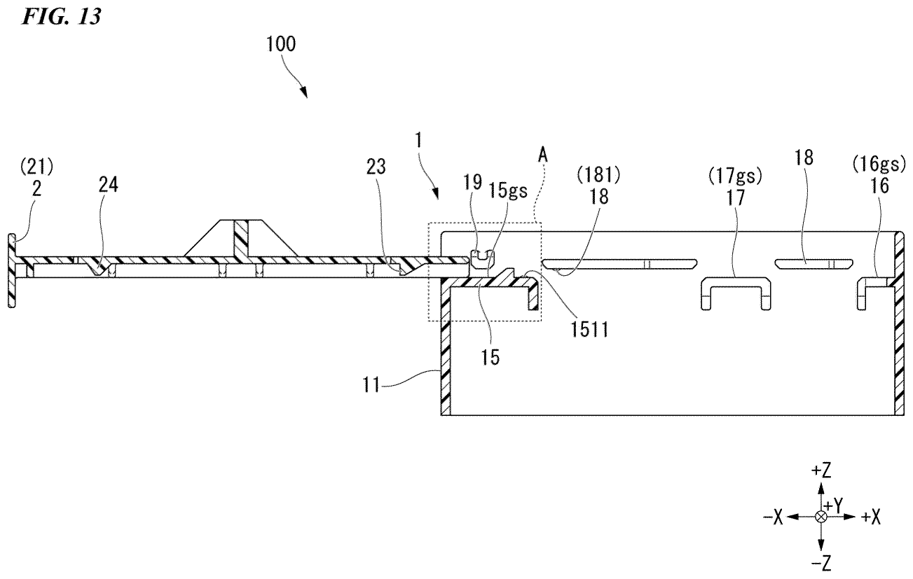

In FIG. 13, a part of the slide cover 2 is inserted into a side surface portion (first wall portion 11) of the cover body 1. When the slide cover 2 is slid in the +X direction from this state, the ear portion 22k2 of the slide cover 2 is introduced between the first rail portion 15 and the restricting portion 19. At this time, the movement of the slide cover 2 in the Z direction is restricted.

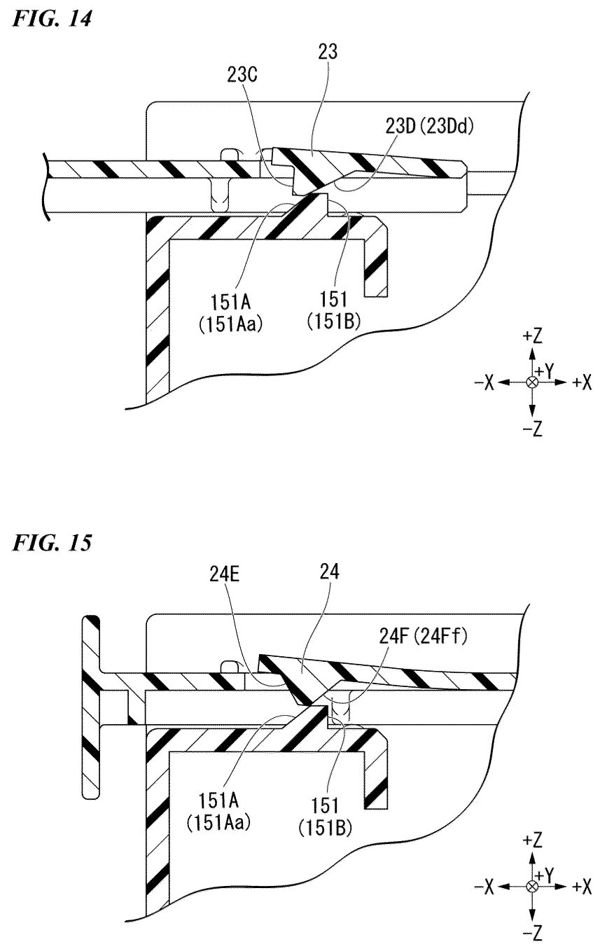

FIG. 14 is a partially enlarged view in which a portion A in FIG. 13 is enlarged. In FIG. 14, the first locking portion 23 and the second locking portion 151 are in contact with each other. When the slide cover 2 is slid in the +X direction from this state, the first locking portion 23 is pressed in the −X direction by the second inclined surface 151Aa of the second locking portion 151. When a predetermined force is applied, the first locking portion 23 swings due to a component force in the +Z direction acting on the first inclined surface 23Dd, and passes over the second locking portion 151.

FIG. 15 is a partially enlarged view in which the portion A in FIG. 13 is enlarged. In FIG. 15, the first locking portion 23 passes over the second locking portion 151, and then the third locking portion 24 and the second locking portion 151 are in contact with each other. When the slide cover 2 is slid in the +X direction from this state, the third locking portion 24 is pressed in the −X direction by the second inclined surface 151Aa. When a predetermined force is applied, the third locking portion 24 swings due to a component force in the +Z direction acting on the fourth inclined surface 24Ff, and passes over the second locking portion 151. In this manner, the slide cover 2 is locked at the locking position in FIG. 12. At this time, the live part is covered by the slide cover 2.

The release of a locking state of the slide cover 2 will be described. When the locking state is released, the live part is exposed to the outside.

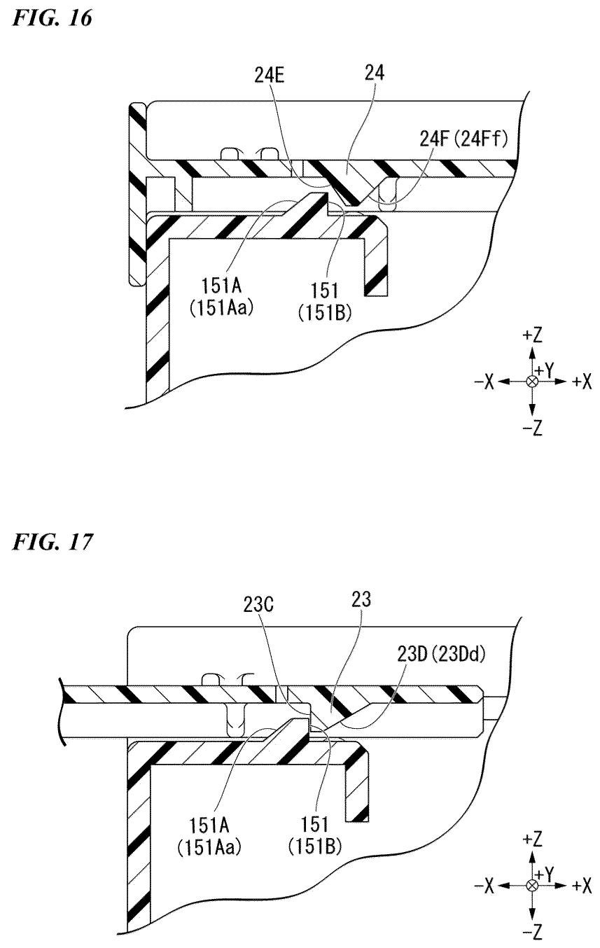

FIG. 16 is a partially enlarged view in which the portion A in FIG. 13 is enlarged. In FIG. 16, the third locking portion 24 and the second locking portion 151 are in contact with each other. Specifically, the third inclined surface 24E of the third locking portion 24 and the end portion ED are in contact with each other. When the slide cover 2 is slid in the −X direction from this state, the third locking portion 24 is pressed in the +X direction by the end portion ED. When a predetermined force is applied, the third locking portion 24 swings due to a component force in the +Z direction acting on the third inclined surface 24E, and passes over the second locking portion 151.

FIG. 17 is a partially enlarged view in which the portion A in FIG. 13 is enlarged. As illustrated in FIG. 17, when the slide cover 2 is slid in the −X direction, the third locking portion 24 passes over the second locking portion 151, and then the first locking portion 23 and the second locking portion 151 are in contact with each other. In this state, the second locking surface 151B and the first locking surface 23C are in surface contact with each other, and a component force in the +X direction is generated on the first locking portion 23. Since no component force in the +Z direction is generated on the first locking portion 23, the first locking portion 23 does not swing. At this time, the first locking portion 23 is not able to pass over the second locking portion 151. Therefore, the slide cover 2 is less likely to come off from the cover body 1.

### (Operations and Effects)

In the present embodiment, an assembly 100 includes a cover body 1 that has a guide surface 15gs facing in a first direction (+Z direction) and an opening EX through which a live part is exposed; and a slide cover 2 that is slid in a second direction (+X direction) along the guide surface 15gs while facing the guide surface 15gs, to close the opening EX. The slide cover 2 has a slide surface 22ss facing the guide surface 15gs when the slide cover is slid, and the slide cover 2 includes a first locking portion 23 that protrudes from the slide surface 22ss in a third direction (−Z direction) opposite to the first direction. The first locking portion 23 has a first locking surface 23C facing in a fourth direction (−X direction) opposite to the second direction, and a first continuous surface 23D continuously arranged in the second direction (+X direction) with respect to the first locking surface 23C. The first continuous surface 23D includes a first inclined surface 23Dd that faces in a direction inclined in the second direction (+X direction) with respect to the third direction (−Z direction). The cover body 1 includes a second locking portion 151 that protrudes from the guide surface 15gs in the first direction (+Z direction). The second locking portion 151 has a second continuous surface 151A, and a second locking surface 151B that is continuously arranged in the second direction (+X direction) with respect to the second continuous surface 151A and faces in the second direction (+X direction). The second continuous surface 151A includes a second inclined surface 151Aa that faces in a direction inclined in the fourth direction (−X direction) with respect to the first direction (+Z direction).

With this constitution, the second locking surface 151B and the first locking surface 23C are in surface contact with each other, and a component force in the +Z direction is less likely to be generated on the first locking portion 23. At this time, the first locking portion 23 is less likely to swing. Accordingly, it is difficult for the first locking portion 23 to pass over the second locking portion 151. As described above, the slide cover 2 is less likely to come off from the cover body 1.

In the present embodiment, the first locking surface 23C is a surface along the first direction (+Z direction), and the second locking surface 151B is a surface along the first direction (+Z direction).

With this constitution, the second locking surface 151B and the first locking surface 23C are in surface contact with each other, and a component force in the +X direction is generated on the first locking portion 23. Since no component force in the +Z direction is generated on the first locking portion 23, the first locking portion 23 does not swing. At this time, the first locking portion 23 is not able to pass over the second locking portion 151. Therefore, the slide cover 2 is less likely to come off from the cover body 1. The effect is expected to be exhibited in a vibration environment such as in a vehicle.

In the present embodiment, the slide cover 2 further includes a third locking portion 24 that is arranged in the fourth direction (−X direction) with respect to the first locking portion 23 and protrudes from the slide surface 22ss in the third direction (−Z direction). The third locking portion 24 includes a third inclined surface 24E facing in a direction inclined in the fourth direction (−X direction) with respect to the third direction (−Z direction), and a third continuous surface 24F continuously arranged in the second direction (+X direction) with respect to the third inclined surface 24E. The third continuous surface 24F includes a fourth inclined surface 24Ff facing in a direction inclined in the second direction (+X direction) with respect to the third direction (−Z direction), and when the slide cover 2 is slid toward the second direction (+X direction), the first locking portion 23 and the second locking portion 151 come into contact with each other, and then the third locking portion 24 and the second locking portion 151 come into contact with each other.

Such a constitution has the following advantages. At the time of releasing the locking state of the slide cover 2, when the slide cover 2 is slid in the −X direction, the third locking portion 24 is pressed in the +X direction by the second locking portion 151. When a predetermined force is applied, the third locking portion 24 swings due to a component force in the +Z direction acting on the third inclined surface 24E, and passes over the second locking portion 151, and thus it is easy to prevent the slide cover 2 from coming off.

In the present embodiment, the first locking portion 23 is swingable from the slide surface 22ss toward a back surface 22bs of the slide surface 22ss, and the third locking portion 24 is swingable from the slide surface 22ss toward the back surface 22bs.

According to such a constitution, the swinging of the first locking portion 23 to pass over the second locking portion 151 and the swinging of the third locking portion 24 to pass over the second locking portion 151 are required to release the locking state, and thus it is easy to prevent the slide cover 2 from coming off.

In the present embodiment, the slide cover 2 includes a first opening portion 22E1 that is open from the slide surface 22ss to a back surface 22bs of the slide surface 22ss, and a second opening portion 22E2 that is open alongside the first opening portion 22E1 in the fourth direction (−X direction), and is open from the slide surface 22ss to the back surface 22bs. The first opening portion 22E1 is a U-shaped opening that sandwiches the first locking portion 23 in a direction (Y direction) along a fifth direction intersecting the first direction (+Z direction) and the second direction (+X direction), and the second opening portion 22E2 is a U-shaped opening that sandwiches the third locking portion 24 in the Y direction.

According to such a constitution, the swinging of the first locking portion 23 to pass over the second locking portion 151 and the swinging of the third locking portion 24 to pass over the second locking portion 151 are required to release the locking state, and thus it is easy to prevent the slide cover 2 from coming off.

In the present embodiment, the cover body 1 includes a rail portion (first rail portion 15) that bridges inner surfaces of both side walls in a direction (Y direction) along a fifth direction intersecting the first direction (+Z direction) and the second direction (+X direction), and a pair of first protrusions (upper protrusions 18) that protrude from the inner surfaces of both the side walls in the Y direction. The rail portion (first rail portion 15) allows the slide cover 2 to be slid along the guide surface 15gs, and the first protrusion (upper protrusion 18) restricts movement of the slide cover 2 in the first direction (+Z direction).

With this constitution, even in a case where a component force in the +Z direction acts on the slide cover 2 due to the inclined surface of the first locking portion 23 or the third locking portion 24, it is easy to suppress movement (rattling) of the slide cover 2 in the first direction (+Z direction).

In the present embodiment, the first protrusion (upper protrusion 18) has a second protrusion (protrusion 181) protruding toward the third direction (−Z direction).

With this constitution, it is easy to suppress movement (rattling) of the slide cover 2 in the first direction (+Z direction). The effect is expected to be exhibited in a vibration environment such as in a vehicle.

In the present embodiment, the rail portion (first rail portion 15) has a pair of third protrusions (protrusions 1511) that protrude toward the first direction (+Z direction), and the third protrusion (protrusion 1511) is arranged in the second direction (+X direction) with respect to the second locking portion 151.

With this constitution, it is easy to suppress movement (rattling) of the slide cover 2 in the first direction (+Z direction). The effect is expected to be exhibited in a vibration environment such as in a vehicle.

### Modification Example

In the example of the present embodiment, the second locking surface 151B and the first locking surface 23C are surfaces along the +Z direction, but the second locking surface 151B and the first locking surface 23C may be surfaces inclined in a specific direction.

For example, the first locking surface 23C may be an inclined surface (hereinafter, also referred to as a “fifth inclined surface 23G”) facing in a direction inclined in the −X direction with respect to the +Z direction. At this time, the second locking surface 151B may be an inclined surface (hereinafter, also referred to as a “sixth inclined surface 151H”) facing in a direction inclined in the +X direction with respect to the −Z direction.

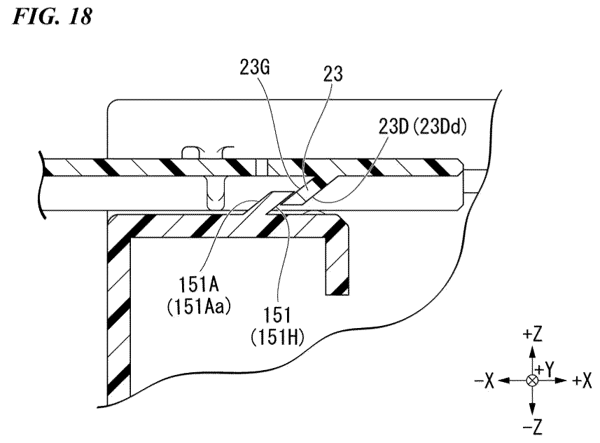

FIG. 18 is a partially enlarged view in which the portion A in FIG. 13 is enlarged. As illustrated in FIG. 18, when the slide cover 2 is slid in the −X direction, the third locking portion 24 passes over the second locking portion 151, and then the first locking portion 23 and the second locking portion 151 are in contact with each other. In this state, the sixth inclined surface 151H and the fifth inclined surface 23G are in surface contact with each other, and a component force in the +X direction is generated on the first locking portion 23. The component force in the −Z direction acting on the fifth inclined surface 23G prevents the first locking portion 23 from passing over the second locking portion 151. Therefore, the slide cover 2 is less likely to come off from the cover body 1.

As described above, the embodiment and the modification example have been described. However, the embodiment and the modification example are not limited to the examples described above. For example, the embodiment and the modification example may be implemented in combination with each other. The above-described embodiment may also be implemented in various other forms, and various additions, omissions, substitutions, and changes may be made without departing from the spirit of the present disclosure.

### INDUSTRIAL APPLICABILITY

According to the present disclosure, a cover material of an assembly is less likely to come off.

### REFERENCE SIGNS LIST

100 assembly
1 cover body
11 first wall portion
11es outer wall surface
11is inner wall surface
12 second wall portion
12es outer wall surface
12is inner wall surface
13 third wall portion
13es outer wall surface
13is inner wall surface
14 fourth wall portion
14es outer wall surface
14is inner wall surface
first rail portion (rail portion)
151 second locking portion
151A second continuous surface
151Aa second inclined surface
151B second locking surface
151H sixth inclined surface
15gs guide surface
15k1 flat portion
15k2 upright portion
1511 protrusion (third protrusion)
16 second rail portion
16gs guide surface
16k1 flat portion
16k2 upright portion
161 protrusion
17 lower protrusion
17gs guide surface
17k1 flat portion
17k2 upright portion
18 upper protrusion (first protrusion)
181 protrusion (second protrusion)
18k1 flat portion
19 restricting portion
19k1 flat portion
19k2 upright portion
191 protrusion
2 slide cover
21 grip portion
22 extension portion
22E1 first opening portion
22E2 second opening portion
22k1 flat portion
22k2 ear portion
22k3 upright portion
22ss slide surface
22bs back surface
23 first locking portion
23C first locking surface
23D first continuous surface
23Dd first inclined surface
23G fifth inclined surface
24 third locking portion
24E third inclined surface
24F third continuous surface
24Pf fourth inclined surface
reinforcement portion
25k1 wall portion
25k2 bridge portion
AA gap
ED end portion
EX opening

What is claimed is:

1. An assembly comprising:
a cover body that has a guide surface facing in a first direction and an opening through which a live part is exposed; and
a slide cover that is slid in a second direction along the guide surface while facing the guide surface, to close the opening,
wherein the slide cover has a slide surface facing the guide surface when the slide cover is slid,
the slide cover includes a first locking portion that protrudes from the slide surface in a third direction opposite to the first direction,
the first locking portion has a first locking surface facing in a fourth direction opposite to the second direction, and has a first continuous surface continuously arranged in the second direction with respect to the first locking surface,
the first continuous surface includes a first inclined surface that faces in a direction inclined in the second direction with respect to the third direction, the cover body includes a second locking portion that protrudes from the guide surface in the first direction,
the second locking portion has a second continuous surface, and a second locking surface that is continuously arranged in the second direction with respect to the second continuous surface and faces in the second direction, and
the second continuous surface includes a second inclined surface that faces in a direction inclined in the fourth direction with respect to the first direction.

2. The assembly according to claim 1, wherein
the first locking surface is a surface along the first direction, and
the second locking surface is a surface along the first direction.

3. The assembly according to claim 1, wherein
the first locking surface is an inclined surface facing in a direction inclined in the fourth direction with respect to the first direction, and
the second locking surface is an inclined surface facing in a direction inclined in the second direction with respect to the third direction.

4. The assembly according to claim 1, wherein
the slide cover further includes a third locking portion that is arranged in the fourth direction with respect to the first locking portion and protrudes from the slide surface in the third direction,
the third locking portion includes a third inclined surface facing in a direction inclined in the fourth direction with respect to the third direction, and a third continuous surface continuously arranged in the second direction with respect to the third inclined surface,
the third continuous surface includes a fourth inclined surface facing in a direction inclined in the second direction with respect to the third direction, and
when the slide cover is slid toward the second direction, the first locking portion and the second locking portion come into contact with each other, and then the third locking portion and the second locking portion come into contact with each other.

5. The assembly according to claim 4, wherein
the first locking portion is swingable from the slide surface toward a back surface of the slide surface, and
the third locking portion is swingable from the slide surface toward the back surface.

6. The assembly according to claim 4, wherein
the slide cover includes
a first opening portion that is open from the slide surface to a back surface of the slide surface, and
a second opening portion that is open alongside the first opening portion in the fourth direction, and is open from the slide surface to the back surface,
wherein the first opening portion is a U-shaped opening that sandwiches the first locking portion in a direction along a fifth direction intersecting the first direction and the second direction, and
the second opening portion is a U-shaped opening that sandwiches the third locking portion in the direction.

7. The assembly according to claim 1, wherein
the cover body includes
a rail portion that bridges inner surfaces of both side walls in a direction along a fifth direction intersecting the first direction and the second direction, and
a pair of first protrusions that protrude from the inner surfaces of both the side walls in the direction,
wherein the rail portion allows the slide cover to be slid along the guide surface, and
the first protrusions restrict movement of the slide cover in the first direction.

8. The assembly according to claim 7, wherein
each of the first protrusions has a second protrusion protruding toward the third direction.

9. The assembly according to claim 8, wherein
the rail portion has a pair of third protrusions that protrude toward the first direction, and
the third protrusions are arranged in the second direction with respect to the second locking portion.
